(19) United States
(12) Patent Application Publication
(10) Pub. No.: US 2003/0084436 A1
(43) Pub. Date: May 1, 2003

(54) System and method for installing applications in a trusted environment

(76) Inventors: Joubert Berger, Atlanta, GA (US); Scott A. Leerssen, Atlanta, GA (US); Craig H. Rubin, Norcross, GA (US)

Correspondence Address: HEWLETT-PACKARD COMPANY, Intellectual Property Administration, P.O. Box 272400, Fort Collins, CO, 80527-2400, US

(21) Appl. No.: 10/013,043

(22) Filed: Oct. 30, 2001

(51) Int. Cl. G06F 9/445; H04L 9/00

(52) U.S. Cl. 717/174; 713/164

(57) ABSTRACT

A system and method for installing applications in a trusted environment is disclosed. The method comprises enabling selection of an application from one or more applications; enabling dragging of a graphical representation of the selected application towards a graphical representation of a compartment of the trusted operating system; and enabling dropping of the graphical representation of the application on the graphical representation of the compartment. In response to the dropping of the graphical representation of the selected application, automatically installing the selected application in the selected compartment.

### TECHNICAL FIELD OF THE INVENTION

The present invention relates generally to the field of computer systems, and more particularly to a system and method for installing applications in a trusted environment.

### BACKGROUND OF THE INVENTION

Computer system security issues have become extremely important as more and more computers are connected to networks, such as the Internet. Attacks on computer systems have become increasingly sophisticated due to the evolution of new hacker tools. Using these tools, relatively unsophisticated attackers can participate in organized attacks on one or more targeted facilities.

Many companies are providing services, such as e-commerce type services, over the Internet. Offering a service over the Internet naturally exposes critical processes, applications, and resources of an enterprise to a large population including attackers capable of probing these resources for vulnerabilities. Increasingly single machines or devices are being used to host multiple applications and services concurrently. Vulnerabilities of one application may be used by attackers to gain access to other applications.

Typically operating systems include a Discretionary Access Control (DAC) policy where access to files is at the discretion of their owners, who can grant permissions to others. The level of protection provided by a DAC policy is thus at the discretion of the individual users setting the permissions. Thus, in a system utilizing only DAC, a compromised resource can violate the integrity of the entire system. As such, some computer systems use a Mandatory Access Control (MAC) policy to control access to system resources. A MAC policy comprises communication rules that control the flow of information on a system. This policy is enforced typically by the kernel and cannot be overridden by a user or a compromised application. It is becoming increasingly important to effectively manage the flow of information between different applications so that only those communications necessary for the different applications to perform their functions are authorized. Consequently, the job of system administrators who have to manage flow control in a system is becoming more complex.

### SUMMARY OF THE INVENTION

In accordance with an embodiment of the present invention, a method for installing an application in a trusted operating system is disclosed. The method comprises enabling selection of an application from one or more applications; enabling dragging of a graphical representation of the selected application towards a graphical representation of a compartment of the trusted operating system; and enabling dropping of the graphical representation of the application on the graphical representation of the compartment. In response to the dropping of the graphical representation of the selected application, automatically installing the selected application in the selected compartment.

In accordance with another embodiment of the present invention, a graphical software installation tool for installing an application in a trusted operating system is disclosed. The graphical software installation tool comprises a graphical user interface. The graphical user interface comprises a display portion displaying at least one compartment of the trusted operating system. The graphical user interface also comprises an application portion comprising a graphical representation of at least one application. The graphical representation of the at least one application is operable to be dragged from the application portion to the display portion, wherein dropping of the graphical representation of the at least one application on a graphical representation of the at least one compartment causes automatic installation of the application in the compartment.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a schematic representation of an exemplary compartment-based trusted operating system on which the teachings of the present invention may be practiced;

FIGS. 2A-2D show exemplary screen displays of a preferred embodiment of a graphical software installation tool of the present invention; and

FIG. 3 is a flowchart illustrating a preferred embodiment method for automatically installing an application in a compartment of the trusted operating system.

### DETAILED DESCRIPTION OF THE DRAWINGS

The preferred embodiment of the present invention and its advantages are best understood by referring to FIGS. 1 through 3 of the drawings, like numerals being used for like and corresponding parts of the various drawings.

Computer systems with trusted operating systems have been generally designed to provide separation between different categories of information. FIG. 1 is a schematic representation of an exemplary compartment-based trusted operating system 100 on which the teachings of the present invention may be practiced. Trusted operating system 100 works on the principle of containment which reduces an application's exposure to attack while at the same time limiting the damage in the event of an attack. By installing applications in separate compartments with controlled communication allowed between the different compartments, damage in the computer system may be isolated to the compromised application.

Compartment-based trusted operating system 100 comprises a plurality of compartments. Applications are installed and processes are run within these separate compartments. Each application and each process is assigned a compartment label. Applications and processes with the same compartment label belong to the same compartment. Thus, if a system is segmented into six compartments—for example, and not by way of limitation, WEB, DB, MAIL, eth0, eth1, and SYSTEM—every application and every process is assigned one of these six labels. The number of compartments and the labels assigned to the compartments is not critical to the invention.

Applications and/or processes in separate compartments cannot communicate with each other unless one or more communication rules 104 explicitly permit that type of communication between the compartments. Communication rules 104 are preferably MAC rules. Whenever an application or a process attempts to access a file or communicate with another application or process, the kernel examines the label of the application or process and consults the MAC rules. The application or process gains access only if the MAC rules authorize that type of access to applications or processes with that label.

A file control table may be used to ensure that applications and processes perform only authorized operations on files. The file control table represents rules, preferably MAC rules, specifying the types of access, for example, read, write, append, or execute, to a file a particular application or process is allowed. An exemplary file control table for the WEB compartment is shown in Table I. Each row of Table I specifies that the application or process with the web compartment label can act on the named file resource according to the specified permissions while the rule status is ‘Active’.

TABLE I

| Compartment | Resource | Permissions | Status |
|---|---|---|---|
| web | /compt/web/apache/logs | read, write, append | active |
| web | /compt/web/tmp | read, write | active |
| web | /compt/web/dev | read, write | active |
| web | /compt/web | read | active |
| web | /bin | read | active |
| web | /lib | read | active |
| web | /sbin | read | active |
| web | /usr | read | active |
| web | / | none | active |

A communication rules table may be provided to represent the permissible flow of information to and from the trusted operating system and among compartments of the trusted operating system. A communication rule may be expressed as:

COMPARTMENT A->COMPARTMENT B PORT P METHOD M NETDEV N

The above communication rule specifies that compartment A may connect to compartment B at port P using method M through network device N. The method may be, for example, tcp, udp, and/or the like. The following example communication rule specifies the communication rule for the flow of information between the DB compartment and the WEB compartment of FIG. 1:

COMPARTMENT db->COMPARTMENT web PORT 9999 METHOD udp NETDEV any

indicating that the DB compartment may connect to the WEB compartment at port 9999 using UDP through any network device.

The exemplary compartments shown in FIG. 1 are a system compartment 140, a database compartment 141, a web compartment 142, a mail compartment 143, a eth0 compartment 144 and a eth1 compartment 145. However, the invention is not so limited and other compartments may be included as desired. Moreover, it is not necessary to have all the compartments shown in FIG. 1. Because of the way communication rules 104 are set-up, in the exemplary embodiment of FIG. 1, DB compartment 141 can only communicate with WEB compartment 142, WEB compartment 142 can only communicate with eth1 compartment 145, eth1 compartment 145 can only communicate with WEB compartment 142, eth0 compartment 144 can only communicate with WEB compartment 142, and MAIL compartment 143 can only communicate with eth0 compartment 144. Because there are no communication rules set-up from SYSTEM compartment 140, it cannot communicate with any other compartment.

If desired, files may be further protected by gathering one or more files into a restricted file system for each compartment. Each compartment may have a section of the file system associated with it. Applications or processes running within a particular compartment only have access to the section of the file system associated with that particular compartment. For example, application and data files of the WEB compartment may be gathered into the /compt/web/ directory.

It should be apparent that installing a new application in the compartment-based trusted operating system as described above with reference to FIG. 1 is typically very cumbersome. The operator installing the new application, typically the system administrator, has to manually perform various tasks and has to keep track of various rules that control the flow of information.

Preferably, a graphical software installation tool 102 according to a preferred embodiment of the present invention is utilized by the system administrator. Graphical software installation tool 102 preferably has a graphical user interface 110 associated with it. Utilizing graphical user interface 110, the system administrator may install a new application in a compartment of the trusted operating system by simply dragging a representation of the application onto a representation of the compartment. The graphical software installation tool automatically performs various tasks required in the installation of the application in the compartment. Preferably, the graphical user interface also allows the operator to create, delete and modify different compartments, set-up communication rules between the compartments, change file access controls and/or the like.

A pointing device, such as a mouse, a trackball and/or the like, which controls a graphical pointer on a display may be used. The graphical pointer provides feedback such that the system administrator may point to a desired selection utilizing the pointing device and receive feedback by viewing the graphical pointer. Pointing and clicking on a representation of the application by keeping the button of the pointing device depressed would allow the system administrator to ‘drag’ the selected application. Releasing the button of the pointing device would allow the system administrator to ‘drop’ the selected application.

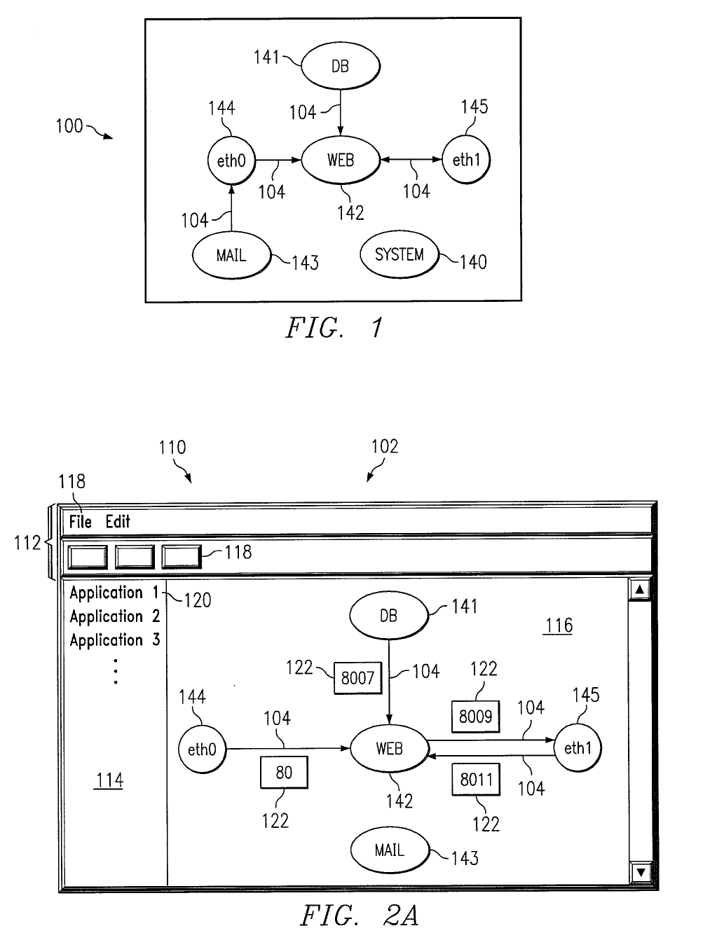

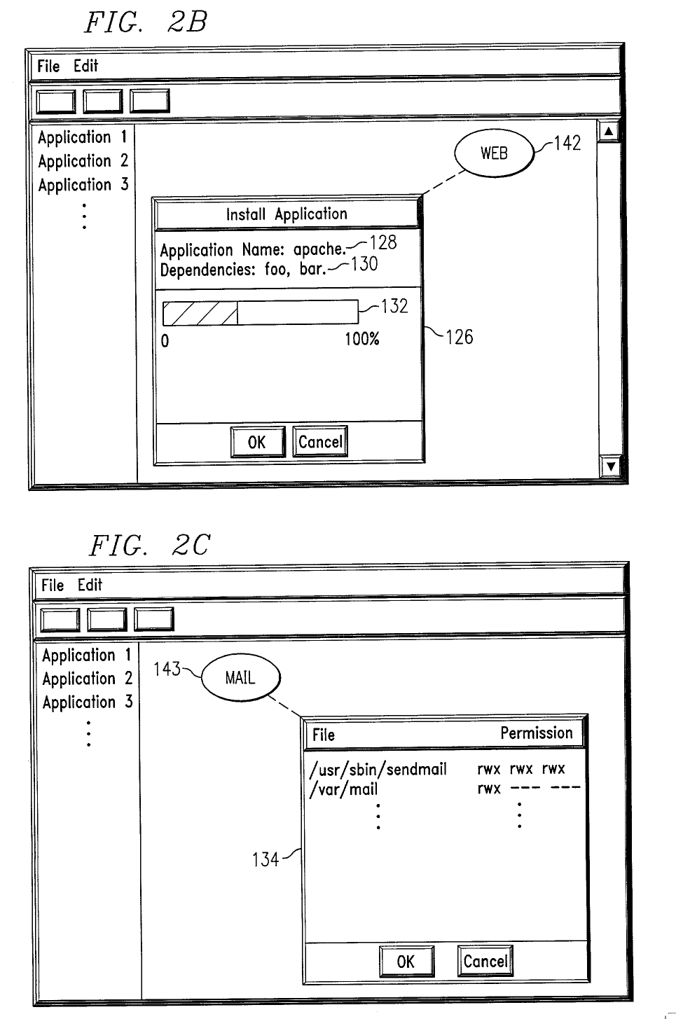

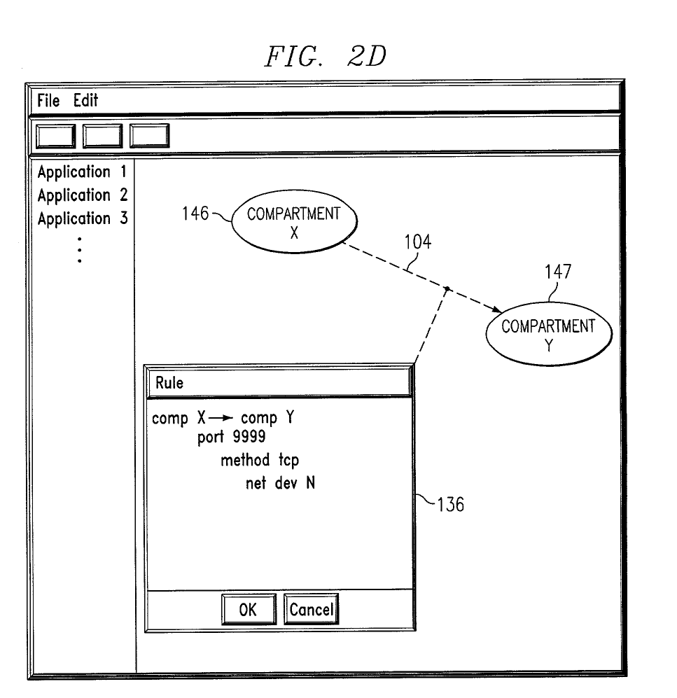

FIGS. 2A-2D show exemplary screen displays of a preferred embodiment of graphical software installation tool 102 of the present invention. Graphical user interface 110 of the graphical software installation tool 102, preferably comprises a control area 112, an application area 114 and a display area 116. Control area 112 preferably includes one or more control elements 118, such as icons, menu items and/or the like. Application area 114 lists one or more applications 120 available for installation in one or more compartments 140 through 145. Applications 120 may be displayed in application area 114 textually, graphically or both depending on the preference of the operator as may be specified via control elements 118.

Display area 116 graphically displays the various compartments, for example compartments 140 through 145, of the trusted operating system and the relationships or communication rules 104 between the different compartments. Communication rules 104 between the different compartments are preferably shown by directional arrows between the graphical representation of the compartments, the directional arrows indicating the direction of communication permitted by the rule. If desired, port numbers 122 through which the compartments, for example compartments 140 through 145, communicate may be shown next to the corresponding communication rules 104.

A compartment database or file which stores the names of the different compartments may be read to facilitate graphical display of the various compartments. Thus, when the name of a compartment, for example MAIL compartment 143, is read from the compartment database, graphical software installation tool 102 draws a graphical representation for that compartment. Graphical software installation tool 102 draws graphical representations for all compartments listed in the compartment database.

A communication rules database or file which stores all of the communication rules may be read to facilitate graphical display of the communication rules between the compartments. Thus, for example, when a communication rule from DB compartment 141 to WEB compartment 142 is read, graphical software installation tool 102 draws a directional arrow representing a communication rule from DB compartment 141 to WEB compartment 142. A port number for the port through which the two compartments communicate may be displayed in proximity to the directional arrow. This process is repeated for all the rules in the communications rules database. Thus, the various compartments and the communication rules associated with the compartments may be graphically displayed.

Application 120 may be installed by simply selecting an appropriate application from application area 114 and dragging it onto the representation of one of the compartments 140 through 145 shown in display area 116. Application 120 may be installed in an already existing compartment or the operator may create a new compartment and drag application 120 onto the new compartment. The new compartment may be created by using control elements 118. For example, the operator may select an icon for a new compartment from control area 112 and drag it into display area 116, where a graphical representation of the new compartment is automatically displayed.

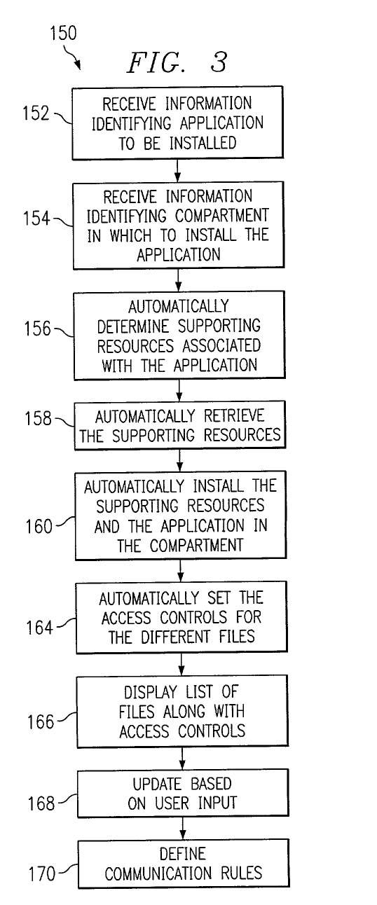

Once application 120 is dragged onto the graphical representation of a compartment, application 120 is automatically installed in that compartment as discussed in more detail hereinbelow with reference to FIG. 3. A status window 126 as shown in FIG. 2B may be displayed as an application is being installed in a compartment, say WEB compartment 142. Status window 126 preferably includes a name field 128 for displaying the name of the application being installed, a dependency field 130 for displaying the dependencies of the application being installed, and an installation meter 132 for displaying the percentage of installation completed.

By ‘right clicking’ on any of the compartments, a pull-down menu may be displayed and appropriate selections made from the pull-down menu. Thus, for example, as shown in FIG. 2C, the access controls for different files and directories in a particular compartment, say MAIL compartment 143 may be displayed on an access control window 134. If desired, the operator may modify the individual access controls for the different files or directories by simply clicking on the appropriate read/write/execute access controls. Preferably, the individual access controls toggle between a set position (indicating permitted access) and a reset position (indicating no access). Once the operator has made the appropriate modifications and clicked an ‘OK’ button associated with access control window 134, the access controls for the affected files and directories may be updated by executing the appropriate system command, for example a ‘chmod’ command.

A communication rule 104 may be graphically defined between two compartments: compartment X 146 and compartment Y 147 by clicking on one of the compartments, say compartment X 146 and dragging the input device pointer associated with the input device to the other compartment, say compartment Y 147. When the input device is released, a directional arrow indicating a communication rule is displayed between the two compartments. Preferably, a communication rule window 136 is displayed. Communication rule window 136 includes a generic communication rule which may be customized by the operator.

Some of the fields in the generic rule, such as the names of the compartments, may be automatically filled. Thus, in the example shown in FIG. 2D, communication rule window 136 may include the following communication rule:

COMPARTMENT X->COMPARTMENT Y PORT 9999 METHOD tcp NETDEV N

The remaining fields, such as port number, method, and network device are preferably filled by the operator. If desired, default values, such as the values used during the creation of the last communication rule may be provided for these fields.

Once the operator has filled the appropriate fields and clicked an ‘OK’ button associated with rule window, communication rule 104 for the two compartments A and B is created.

FIG. 3 is a flowchart 150 illustrating a preferred embodiment method for automatically installing an application in a compartment of a trusted operating system. In step 152, information identifying application 120 to be installed is received, preferably from graphical user interface 110. In step 154, information identifying the compartment in which application 120 is to be installed is received, preferably from graphical user interface 110. The operator may select application 120 from application area 114 and drag it onto a compartment in display area 116 using the input device to provide information to graphical software installation tool 102 regarding the application to be installed and the compartment in which to install the application.

If desired, in an alternative embodiment, the operator may select an application to be installed by clicking on one or more control elements 118 and selecting an application from a pull down menu. The operator may also select a compartment in which to install the selected application, for example by clicking on one or more control elements 118 and selecting a compartment from a pull down menu to provide information to graphical software installation tool 102 regarding the application to be installed and the compartment in which to install the application.

In step 156, supporting resources, such as libraries, configuration files, and/or the like, desirable to install application 120 in the selected compartment are automatically determined. The supporting resources may be determined, for example, by querying an executable file associated with application 120 itself. The executable file includes an area where all resources desirable to properly install the application are listed. A system command, such as LDD, available on trusted operating system 100 may be used for querying the executable file for determining the resources desirable to install application 120. In step 158, the supporting resources are automatically retrieved. The resources may be retrieved from different portions of the file system of trusted operating system 100. In step 160, application 120 and the supporting resources are automatically installed in the selected compartment. Preferably, each file of application 120 and the supporting resources are assigned a compartment label corresponding to the compartment in which application 120 and the supporting labels are installed. If desired, application 120 and the supporting resources may be installed in a restricted file system associated with the compartment in which application 120 is installed.

In step 164, default access controls for different files associated with the application being installed are automatically set. Access controls specify the type of access that is allowed to a file by different applications/processes and may be selected from read, write, append, execute and/or the like. Preferably, in order to minimize damage to the system in case of a breach, only the minimum access necessary for any file is allowed.

The setting of access controls for the different files may be based on the type of file, the location of the file within the file system, and/or the like. A rules database may be provided for this purpose. The rules database may include information as to the default access controls to be provided to any file. For example, the rules database may specify that if the extension for a file is ‘html’, then that file is an HTML output file. The owner of the file needs to be able to read the file and write to the file. However, others only need to read from such a file. Therefore, the rules database may specify that the default access control permissions for an HTML output file is rw-r-r-. The rules database may also specify that all files in a particular directory default to a particular type of access control. For example, access control permissions for all files in a directory which stores, say only executable files, be set to rwx-x-x. Thus, access controls for the different files and directories may be automatically set. This may be accomplished by executing the appropriate system command, for example ‘chmod’ in the UNIX® or LINUX® operating system.

In step 166, the default access controls for the different files and directories associated with the particular application being installed are displayed preferably on an access control window. The access control window is preferably similar to access control window 134 of FIG. 2C. Thus, an operator may view the default access controls set for the different files. If desired, the operator may modify the individual access controls for the different files and/or directories as described above with reference to access control window 134 of FIG. 2C.

In step 168, the access controls for the files and directories may be updated if the operator has modified any of the access controls. In the preferred embodiment, the access controls for only the affected files and directories are changed by executing the appropriate system command, for example a ‘chmod’ command. However, if desired, access controls may be updated for all the files and directories associated with the particular application being installed. This may be desirable if there are a small number of files and directories associated with the application being installed. One of the advantages of updating the access controls for all the files and directories associated with the particular application being installed is that there is no need to keep track of the individual files and directories whose access control has been modified by the operator.

If desired, in step 170, one or more communication rules for communication with the compartment in which the application has been installed are defined. This may be desirable if the compartment in which the new application is installed is a new compartment or the communication rules have to be updated in view of the installation of the new application. For example, if a web server application is installed in a compartment that does not currently allow a host to access it via the Internet, one or more new communication rules allowing one or more hosts to access the particular compartment via the Internet have to be defined. Communication rules may be defined, for example, by the method described above with reference to FIGS. 2A-2D. For the web server application example, the two compartments between which a communication rule is defined could be the WEB compartment and the compartment with which a network card is associated, for example, the eth0 compartment of FIG. 1.

A communication rule preferably defines one way communication between the two compartments with the communication allowed from the compartment in which the graphical representation of the communication rule originates to the compartment in which the graphical representation of the communication rule terminates. However, in many instances two way communication between compartments is desirable. Accordingly, the rules database may also include information regarding compartments in which two way communication is desirable. Thus, if the operator only defines a communication rule establishing one way communication between two compartments when two way communication is desirable, the graphical software installation tool of the preferred embodiment may automatically define a second communication rule between the two compartments and graphically represent the second communication rule in display area 116 of graphical user interface 110 so that the automatically defined communication rule may be visible to the operator. If desired, graphical software installation tool 102 may simply prompt the operator to define a second communication rule or to modify an automatically defined second communication rule.

Graphical software installation tool 102 of the preferred embodiment of the present invention may be utilized on a computer system using any operating system, such as LINUX®, UNIX®, AIX®, HP-UX® and/or the like, now know or later developed. However, it is most advantageous when used in a computer system with a trusted operating system utilizing the concept of compartments to reduce the extent to which data stored on the computer system is compromised in case of attack by hackers.

What is claimed is:

1. A method for installing an application in a trusted operating system, comprising:
enabling selection of an application from one or more applications;
enabling dragging of a graphical representation of said selected application towards a graphical representation of a compartment of said trusted operating system;
enabling dropping of said graphical representation of said application on said graphical representation of said compartment; and
automatically installing said selected application in said selected compartment in response to said dropping of said graphical representation of said selected application.

2. The method of claim 1, further comprising:
automatically determining one or more supporting resources associated with said selected application;
automatically retrieving said supporting resources; and
automatically installing said supporting resources within said selected compartment.

3. The method of claim 1, further comprising:
automatically determining access controls for one or more files associated with said selected application; and
automatically setting said determined access controls for said one or more files.

4. The method of claim 3, further comprising displaying said access controls along with the files with which said access controls are associated.

5. The method of claim 3, further comprising modifying said access controls in response to a user input.

6. The method of claim 2, wherein said automatically determining one or more supporting resources comprises automatically selecting one or more library files.

7. The method of claim 2, wherein said automatically determining one or more supporting resources comprises automatically selecting one or more configuration files.

8. The method of claim 2, wherein said automatically determining one or more supporting resources comprises querying an executable file of said selected application to automatically determine said one or more supporting resources associated with said application.

9. The method of claim 3, wherein said automatically determining access controls comprises automatically determining access controls for at least one of said files based at least in part on the type of the file.

10. The method of claim 3, wherein said automatically determining access controls comprises automatically determining access controls for at least one of said files based at least in part on the location of the file.

11. The method of claim 1, wherein said enabling dropping of said graphical representation of said application on said graphical representation of said compartment comprises enabling dropping of said graphical representation of said application in close proximity to said graphical representation of said compartment.

12. A method for installing an application in a compartment-based trusted operating system, comprising:
displaying a graphical representation of a plurality of compartments of said trusted operating system;
enabling dragging of a graphical representation of said application towards a graphical representation of a compartment of said plurality of compartments;
enabling dropping of said graphical representation of said application on said graphical representation of said compartment; and
automatically installing said application in said selected compartment in response to said dropping of said graphical representation of said compartment.

13. The method of claim 12, further comprising:
automatically determining one or more supporting resources associated with said application;
automatically retrieving said supporting resources; and
automatically installing said supporting resources within said selected compartment.

14. The method of claim 12, further comprising:
automatically determining access controls for one or more files associated with said selected application; and
automatically setting said determined access controls for said one or more files.

15. The method of claim 14, further comprising assigning a compartment label unique to said compartment to each of said supporting resources.

16. The method of claim 12, wherein said enabling dropping of said graphical representation of said application on said graphical representation of said compartment comprises enabling dropping of said graphical representation of said application in close proximity to said graphical representation of said compartment.

17. A graphical software installation tool for installing an application in a trusted operating system, comprising:
a graphical user interface, comprising:
a display portion displaying at least one compartment of said trusted operating system; and
an application portion comprising a graphical representation of at least one application, said graphical representation of said at least one application operable to be dragged from said application portion to said display portion, wherein dropping of said graphical representation of said at least one application on a graphical representation of said at least one compartment causes automatic installation of said application in said compartment.

18. The graphical software installation tool of claim 17, further comprising:
means for automatically determining one or more supporting resources associated with said at least one application;
means for automatically retrieving said supporting resources; and
means for automatically installing said supporting resources within said at least one compartment.

19. The graphical software installation tool of claim 17, further comprising:
means for automatically determining access controls for one or more files associated with said at least one application; and
means for automatically setting said determined access controls for said one or more files.

20. The graphical software installation tool of claim 19, further comprising:
means for displaying said access controls along with the files with which said access controls are associated; and
means for modifying said access controls in response to a user input.

21. The graphical software installation tool of claim 19, wherein said means for automatically determining access controls comprises:
means for automatically determining access controls for at least one of said files based at least in part on the type of the file; and
means for automatically determining access controls for at least another one of said files based at least in part on the location of the file.

22. A method for installing an application in a trusted operating system, comprising:
enabling selection of an application from one or more applications;
enabling association of said selected application with a compartment of the trusted operating system; and
automatically installing said selected application in said selected compartment in response to said association of said selected application with said selected compartment.

23. The method of claim 22, wherein said enabling association of said selected application comprises:
enabling dragging of a graphical representation of said selected application towards a graphical representation of said selected compartment; and
enabling dropping of said graphical representation of said selected application on said graphical representation of said selected compartment.

24. The method of claim 23, wherein said enabling dropping of said graphical representation of said selected application on said graphical representation of said selected compartment comprises enabling dropping of said graphical representation of said selected application in close proximity to said graphical representation of said selected compartment.

25. The method of claim 22, further comprising:
automatically determining access controls for one or more files associated with said selected application;
automatically setting said determined access controls for said one or more files;
displaying said access controls along with the files with which said access controls are associated; and
modifying said access controls in response to a user input.
